(19) United States
(12) Patent Application Publication
(10) Pub. No.: US 2021/0220744 A1
(43) Pub. Date: Jul. 22, 2021

(54) GAME APPARATUS AND COMPUTER SYSTEM WITH FALLING LETTERS AND WORD FORMING MECHANICS

(71) Applicant: Dmytro Poluektov, Seattle, WA (US)

(72) Inventor: Dmytro Poluektov, Seattle, WA (US)

(21) Appl. No.: 16/746,375

(22) Filed: Jan. 17, 2020

(51) Int. Cl. A63F 13/80; A63F 13/52

(52) U.S. Cl. CPC A63F 13/80; A63F 2300/8094; A63F 13/52

(57) ABSTRACT

Game control is such that letters fall randomly from above and are then piled up below on the bottom. When the player selects any of the falling letters and issues command to move them left or right, the letters move as left or right, respectively. When the letters complete the fall to the buttom as a result of horizontally moving them while they were vertically falling and form words diagonally, vertically or horizontally, in a crossword fashion, in the pile of letters, the player can then clear letters that form real dictionary defined words. On the other hand, when the letters complete the fall to the buttom and do not form words diagonally, vertically or horizontally, they cannot be cleared and remain in place. The game ends when the game space is completely filled with letters.

### FIELD OF THE INVENTION

The present invention relates to a game in which the user operates a plurality of letter characters that are falling to re-arrange positions of the letters and clear the characters and, more particularly, to the control technique and the crossword style clearing technique of the characters to be re-arranged.

### BACKGROUND OF INVENTION

Typically, games categoried as the so called “falling block games’ such as Tetris and Columns are commonly available in the electronic or computer game market. The “falling block game” is a type of electronic game in which

objects fall from the top part a display area to the bottom part to be matched in likeness to clear the objects.

The primary game principle of matching objects to clear them is borrowed from earlier generation games such as SameGame. These games have a common rule of matching their assorted regular shaped objects to clear them.

However both types of maching object games—matching static objects games and matching falling objects games have principal object variety set limitations as necessitated by the requirement of using regular shaped objects such as squares, circles and equilateral triangles.

For example in Tetris, the player is limited to a set of of at most 19 fixed tetrominos.

### SUMMARY OF THE INVENTION

The object of this invention is to solve the above problem of limited decision play sets in falling block games.

In order to solve the above problems, according to the present invention, the player controls not regular shaped object blocks but instead the player horizontally controls vertically falling letter characters, effectively making this invention a “falling letter game”. Intead of matching falling regular shaped geometric shapes to fit into larger regular geometric shapes, the player instead controls falling letters to fit into words. This expands the user play set by four orders of magnitude from about a dozen block items in traditional “falling block games” to the user play set of about half a million words in the case of English letter character set (Webster's Third New International Dictionary, Unabridged includes some 470,000 words). Unlike traditional “falling block games”, the present “falling letter game” invention also falls into category of edutainment software suitable for educational purposes of vocabulary building, mutlitasking and priority control.

According to the present invention, while letter characters are vertically falling, player moves them left or right to their final horizontal place on the bottom with the goal of matching the given character to another bottom character horizontally, vertically or diagonally, to clear the word. The player can also horizontally control multiple simultaneously falling character letters through vertical up and down character letter selection on higher difficulty game levels. When a word is statically formed horizontally, vertically or diagonally by bottom letters combination by arranging a plurality of falling letter characters, the word is cleared when the user selects all the adjacent inline static word letters and the word is real with existing common dictionary definition. Scores are awarded based on number of letters cleared and word length mutipliers where characters cleared as part of longer words are scored higher and characters cleared as part of shorter words are scored lower. The game ends when the game space is completely filled with letters.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows a basic display example of a game according to an embodiment of the present invention;

FIG. 2 shows a player word clearing example move;

FIG. 3 shows remaining character letters fall after a player's word clearing move;

FIG. 4 is a view after player's word clearing and subsequent letter fall have been completed;

FIG. 5 is a view of player horizontally moving a falling letter character;

FIG. 6 shows player's completed horizontal move of a falling letter character;

FIG. 7 is a view of player selecting the previously moved and now fallen letter character and an adjacent letter character to form and clear a word;

FIG. 8 shows the selected real word has been cleared from the game board;

### DETAILED DESCRIPTION OF THE PREFERRED EMBODIMENT(S)

An embodiment that helps to understand the generic concept will be described hereinafter.

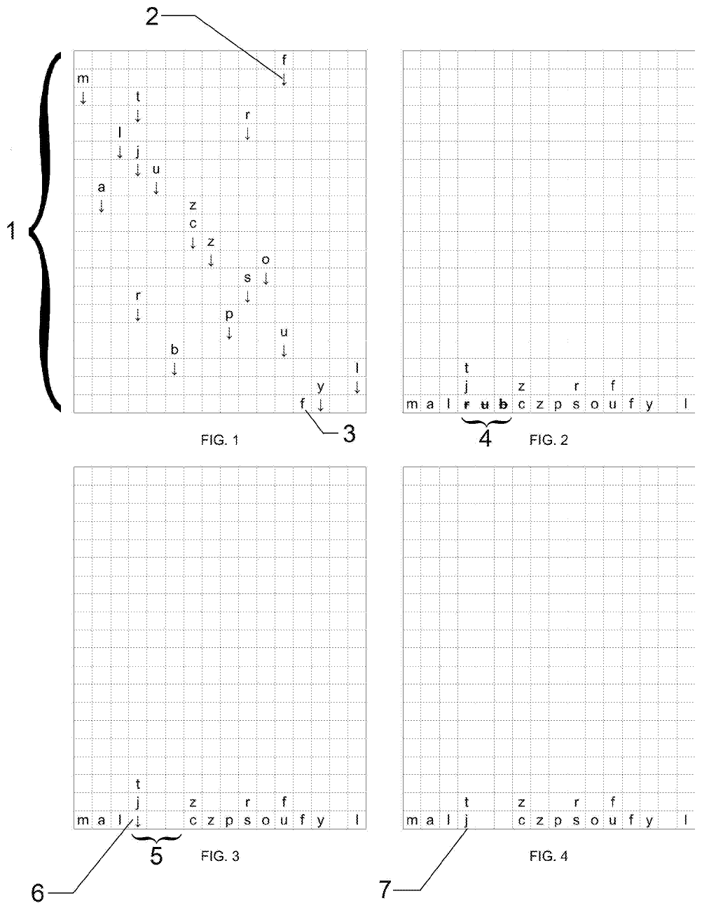

FIG. 1 shows a normal basic display example of a game according to this embodiment. The concept of this game will be explained first. In this game, letters fall from above (the upper portion of a display area of a display screen) toward the bottom (the lower portion of the display area of the display screen), and the player designates and re-arranges a plurality of letters which are falling to the bottom (the lower portion of the display area of the display screen). The letters that completed the fall to the bottom and have inline letter word forming adjacencies can be selected by player to be cleared.

On the field 1 in FIG. 1, falling downward one character space per time tick letter 2 is the last random character seen in the given game screen that has intereted the game board. In the same game screen in FIG. 1 the first letter character 3 that has entered the game board has reached the bottom and is statically located.

For the purposes of readability and clarity no new falling letter characters are introduced in the given sample game space. In FIG. 2, all the given letter characters have completed their fall (one character space per time tick) and are shown static at the bottom of the game screen. The player is shown to have found a valid word in 4 and has selected all the characters of the word to clear it.

FIG. 3 shows the game has recognized the selection as a valid word and has cleared the game characters of that word in 5. 6 shows the remaining non word matching characters will drop down on the game board in the next time tick. FIG. 4 shows the next time tick where the remaining characters have dropped down as seen in 7. However there are currently no word forming character combinations to clear.

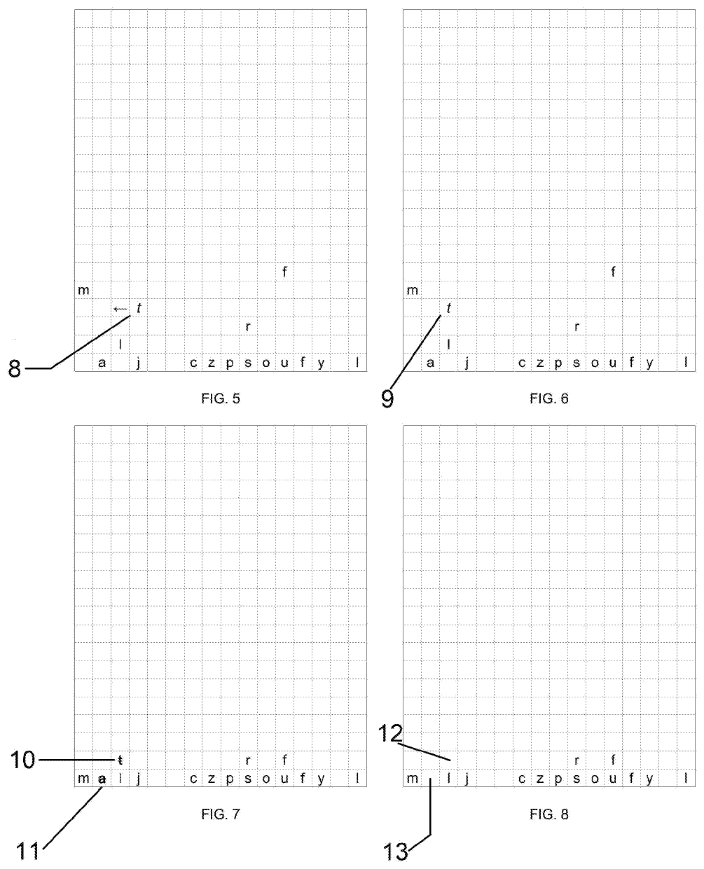

FIG. 5 shows player action in 8 moving a falling character horizontally to have it form a word forming inline character sequence upon its completion of the drop. FIG. 6 shows this completed user move in 9. Note that it also shows that the user can manually vertically select control focus through the falling characters as the character 8 in FIG. 5 was not the last or the first game letter character that entered the game space.

FIG. 7 showing the character previously horizontally moved in FIG. 6 having completed its vertical drop and the player having selected the characters 10 and 11 to clear a newly formed word.

FIG. 8 shows the game recognized the user selected inline character sequence as a valid word and cleared the sequence of characters from the screen, with empty spaces remaining in 12 and 13.

What is claimed is:

1. A computer system and

2. Game apparatus comprising of:
a) a processor,
b) an operation unit which inputs an operation to a game,
c) a display unit which displays information associated with the game, and
d) a computer-readable storage unit which stores program instructions and data required to execute the game,
e) wherein execution of the program instructions by said processor controls the computer system to:
I. generate display data of falling character letters which are displayed to fall from an upper portion to a lower portion in a predetermined display area on the display unit, and storing the display data in the storage unit;
II. read-out the generated display data of the falling character letters from the storage unit, and displaying the falling character letters to fall from the upper portion to the lower portion in the predetermined display area;
III. change, when the falling character letters reach a falling stop position in the display area, the display data to display the falling character letters as stop character letters whose falling movement stops, and storing the changed display data in the storage unit;
IV. designate the predetermined number or less of stop character letters in accordance with a designation instruction from the operation unit; and
V. clear, when the stop character letters are player designated and computer system dictionary validated as valid words, the display data of stop character letters to re-arrange positions of the designated stop character letters in accordance with a re-arrange instruction from the operation unit, and storing the changed display data in the storage unit;
